(19) United States
(12) Patent Application Publication
(10) Pub. No.: US 2016/0261481 A1
(43) Pub. Date: Sep. 8, 2016

(54) DATA COLLECTION SYSTEM, DATA COLLECTION METHOD, SERVER, AND GATEWAY

(71) Applicant: HITACHI, LTD., Tokyo (JP)

(72) Inventors: Yuji OGATA, Tokyo (JP); Kazumasa TOKUHASHI, Tokyo (JP); Yuji TSUSHIMA, Tokyo (JP)

(73) Assignee: HITACHI, LTD., Tokyo (JP)

(21) Appl. No.: 15/006,254

(22) Filed: Jan. 26, 2016

(30) Foreign Application Priority Data
Mar. 4, 2015 (JP) 2015-042036

(51) Int. Cl. H04L 12/26; H04L 29/08

(52) U.S. Cl. CPC H04L 43/10; H04L 67/12

(57) ABSTRACT

In a data collection system in which a server and a gateway are connected to each other and which includes a plurality of sensors installed on a subject of monitoring and outputting sensor data, the server selects a collection rule to change the granularity of the sensor data when it is detected on the basis of the sensor data that an abnormality or a sign of abnormality has occurred in the subject of monitoring, and the server transmits the collection rule to the gateway. The gateway acquires and manages states of the sensors, selects a first condition according to the collection rule received from the server, changes a setting for acquiring the sensor data on the basis of the first condition and the states of the sensors, acquires sensor data from the sensors on the basis of the setting, and transmits the sensor data to the server.

### TECHNICAL FIELD

The present invention relates to a technique for a gateway device to collect data from a sensor on the basis of collection rules.

### BACKGROUND ART

In plants, industrial facilities and the like, a large number of sensors are installed on machine equipment and the like, and a technique in which a computer collects data from the sensors and makes a diagnosis on the machine equipment is used. There are a wide range of inspection items for the machine equipment and there are a large number of subjects of monitoring in the plants and industrial facilities. Moreover, the frequency at which the sensors acquire physical quantities is several milliseconds to several seconds. Therefore, in the case of collecting data from the sensors via a network, the problem of increased communication costs arises.

To reduce communication costs, for example, PTL 1 is an apparatus maintenance diagnosis system in which a sensor collects operation data of machine equipment as a subject of diagnosis, then the collected operation data is coded to compress the data volume, the compressed data is transmitted to the side of central facilities in a remote location from the machine equipment, and a computer on the central facilities side makes a diagnosis on the machine equipment on the basis of the compressed data.

On the side of the industrial facilities where the machine equipment is installed, a preliminary diagnosis of a sign of deterioration of the machine equipment is made, using the operation data gathered by the sensor. If it is determined on the industrial facilities side that a detailed diagnosis is needed, compressed data relating to inspection items on which a detailed diagnosis is to be made is transmitted to the central facilities side. A system where the computer on the central facilities side makes a detailed diagnosis, comparing the received compressed data of inspection items that need a detailed diagnosis with the data at the time of failures in the past, is proposed.

Also, according to PTL 2, on the basis of the result of an abnormality sign diagnosis carried out on time series data collected from an apparatus, an allowable error for compression of the collected data is set. Thus, a technique of reducing the amount of data stored, by carrying out data compression if the result of the diagnosis is normal, but restricting data compression during a period when a sign of an abnormality in the apparatus is detected, is proposed.

### CITATION LIST

### Patent Literature

[PTL 1] Japanese Patent No. 4103467

[PTL 2] Japanese Patent No. 5435126

### SUMMARY OF INVENTION

### Technical Problem

According to the techniques of the above PTL 1 and PTL 2, it is not possible to select time series sensor data collected from the apparatuses or to change the frequency of collection, on the basis of the result of the abnormality sign diagnosis. That is, in the system where the computer on the central facilities side collects, via a network, data acquired by the sensors on the machine equipment, monitoring of the machine equipment is carried out, receiving data from a large number of sensors. In order for the computer on the central facilities side to control each sensor in addition to processing the data from the large number of sensors, the processing load on the computer increases and the network band is overstretched as well. Therefore, it is difficult for the computer on the central facilities side to select time series sensor data collected from the machine equipment or to change the frequency of collection of the sensor data.

In order to control the data collection method when values indicating the degree of load on the machine equipment as a subject of diagnosis, the degree of fatigue and the degree of abnormality change greatly, it is necessary to change programs in the machine equipment and collection parameters in the sensors according to the respective degrees. This poses the problem of complicated procedures for setting change in the machine equipment and sensors, and increased operation costs.

In view of the foregoing problems, an object of the invention is to provide a data collection system, a data collection device and a data collection method in which an increase in load on the computer on the central facilities side or on the network is restrained and in which the granularity of data collected from sensors is changeable.

### Solution to Problem

According to the invention, a data collection system includes: a server having a processor and a memory; a gateway having a processor and a memory; a first network connecting the server to the gateway; a plurality of sensors which is installed on a subject of monitoring and outputs sensor data; and a second network connecting the sensors to the gateway. The server includes: an abnormality sign detecting unit which receives the sensor data outputted by the sensors from the gateway and detects that an abnormality or a sign of abnormality has occurred in the subject of monitoring on the basis of the sensor data; a collection rule changing unit which, when an abnormality or a sign of abnormality has occurred in the subject of monitoring, selects a collection rule to change granularity of the sensor data according to the abnormality or the sign of abnormality; and a collection rule transmitting unit which transmits the selected collection rule to the gateway. The gateway includes: a sensor state storing unit which acquires and manages states of the sensors; a collection rule selecting unit which selects a preset first condition according to the collection rule received from the server and changes a setting for acquiring the sensor data on the basis of the first condition and the states of the sensors; a sensor receiving unit which acquires sensor data from the sensors on the basis of the setting; and a data transmitting unit which transmits the sensor data to the server.

### Advantageous Effect of Invention

According to the invention, the server transmits a collection rule to the gateway when a predetermined even (an abnormality or a sign of abnormality in the subject of monitoring) has occurred. The gateway controls the granularity of sensor data so as to meet the collection rule. Thus, the control of sensor data can be realized by the server simply with a transfer of a collection rule, thus reducing the volume of communications in the network, and an increase in the processing load on the server and in the operation costs can be restrained.

### BRIEF DESCRIPTION OF DRAWINGS

FIG. 1 is a block diagram showing a first example of the invention and showing an outline of a data collection system.

FIG. 2 is a block diagram showing the first example of the invention and showing an example of the configuration of the data collection system.

FIG. 3 is a block diagram showing the first example of the invention and showing an example of the configuration of a central facilities server.

FIG. 4 is a block diagram showing the first example of the invention and showing an example of the configuration of a gateway.

FIG. 5 is a sequence chart showing the first example of the invention and showing an example of processing of giving a collection rule command and collecting data from sensors, carried out in the data collection system.

FIG. 6 is a view showing the first example of the invention and showing an example of a circumstance pattern table managed by a circumstance pattern storing unit.

FIG. 7 is a view showing the first example of the invention and showing an example of a collection rule table managed by a collection rule storing unit.

FIG. 8 is a view showing the first example of the invention and showing an example of a collection rule change condition table managed by a collection rule change condition storing unit.

FIG. 9 is a view showing the first example of the invention and showing an example of a sensor state table managed by a sensor state storing unit.

FIG. 10 is a flowchart showing the first example of the invention and showing an example of processing carried out by a collection rule changing unit in the central facilities server.

FIG. 11 is a flowchart showing the first example of the invention and showing an example of processing carried out by a collection rule selecting unit in the gateway.

FIG. 12 is a block diagram showing a second example of the invention and showing an example of the configuration of a gateway and a subordinate network.

### DESCRIPTION OF EMBODIMENTS

Hereinafter, embodiments of the invention will be described on the basis of the accompanying drawings.

### Example 1

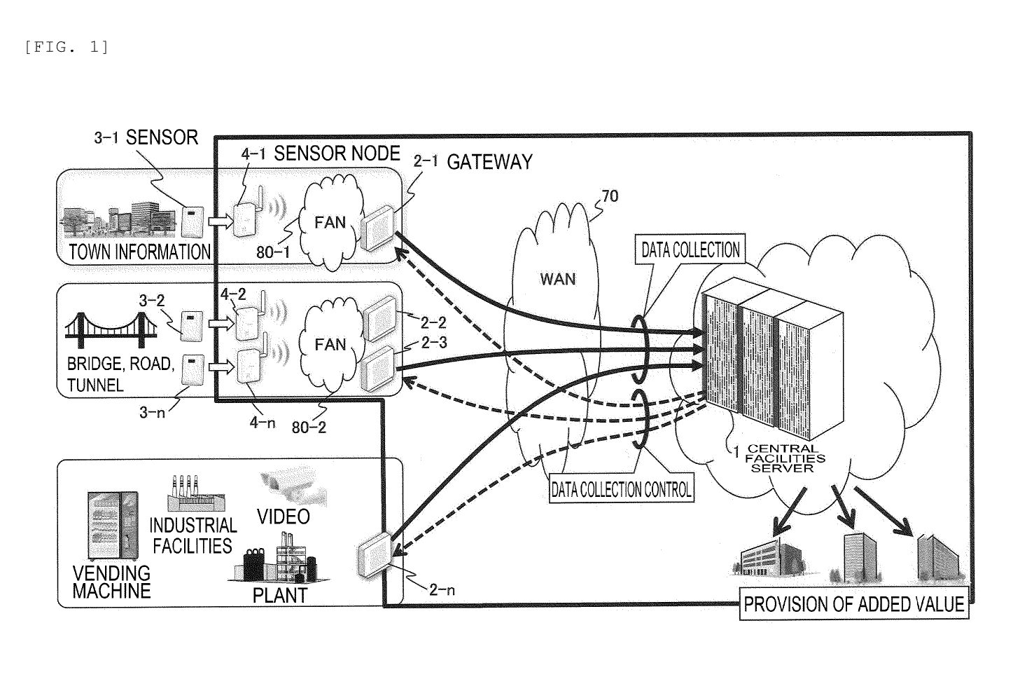

FIG. 1 is a block diagram showing an example of the invention and showing an outline of a data collection system. In the data collection system according to the invention, a plurality of sensors 3-1 to 3-n which measures a physical quantity such as vibrations or temperature is arranged on a machine, facility or structure to be a subject of monitoring. The data measured by the sensors 3-1 to 3-n are transmitted from gateways 2-1 to 2-n to a central facilities server 1 via a network (WAN) 70. It should be noted that the entirety of the sensors 3-1 to 3-n is denoted by the number “3” without “-” or subsequent sign, whereas the numbers with “-” and the subsequent signs are used to denote the individual sensors. Hereinafter, the same applies to the signs of other components.

In FIG. 1, a sensor node (wireless communication unit) 4-1 connected to the sensor 3-1 is connected to the gateway 2-1 via a FAN (Field Area Network) 80-1 that is a wireless communication network. The network connecting the sensor 3 to the sensor node 4 is not limited to wireless communication and these components may also be connected via a wire. The gateway 2 is a relay device which relays communications between different networks, and can include a router or the like, for example. Also, the FAN 80 is not limited to wireless communication and may include wired communication. The number of the sensors 3 connected to the sensor node 4 and the number of the sensor nodes 4 connected to the gateway 2 are not limited to those numbers and various forms can be employed. For example, a configuration in which a plurality of sensor nodes 4 is connected to the gateway 2 and a configuration in which a plurality of sensors 3 is connected to the sensor node 4 may also be employed.

Also, a correspondence between the gateway 2 and the sensor node 4 is set in advance. The gateway 2 communicates with the subordinate sensor node 4 thereof.

On one subject of monitoring, one or a plurality of sensors 3 is arranged, and at least one gateway 2 is arranged for each subject of monitoring. The gateway 2 transfers the data collected from the sensor 3 (hereinafter referred to as sensor data) to the central facilities server 1 via the WAN 70. A plurality of subjects of monitoring subordinate to the gateway 2 may exist.

The gateway 2 monitors the state of the subordinate sensor 3 and controls the sensor 3, in addition to the collection of sensor data. The example of FIG. 1 illustrates an example in which the sensor 3 subordinate to the gateway 2 is connected thereto via the sensor node 4. However, this example is not limiting. For example, if the number of the sensors 3 is large, or if the apparatus or facility in the subject of monitoring is remote, a plurality of gateways 2 may be connected hierarchically. Also, a plurality of gateways 2 may be connected to one sensor node 4.

The central facilities server 1 carries out valued-added information processing such as monitoring of the subject of monitoring, visualization of the sensor data, analysis of the sensor data, or prediction of a failure in the subject of monitoring, on the basis of the sensor data received from the gateway 2, and provides the resulting information for a client such as the user who maintains the subject of monitoring.

Also, if the central facilities server 1 detects a failure (abnormality) or a sign of failure (abnormality) in the sensor data of the subject of monitoring, the central facilities server 1 sends a command to improve the granularity of sensor data to be collected, to the gateway 2 collecting this sensor data. The gateway 2 changes the setting of the sensor 3 so as to meet the command from the central facilities server 1, according to the state of the subordinate sensor 3, and improves the granularity of data to be collected from the sensor 3. The setting of the sensor 3 can include the number of the sensors 3, as described below. Also, the granularity of sensor data includes the frequency of collection of sensor data and the number of data that increases or decreases according to the number of sensors for collection.

As the sensor data of the subject of monitoring returns to normal, a command to lower the granularity of sensor data to be collected is sent. The gateway 2 changes the setting of the sensor 3 so as to meet the command from the central facilities server 1, according to the state of the subordinate sensor 3, and lowers the granularity of sensor data to be collected from the sensor 3. Thus, the communication load on the FAN 80 and the WAN 70 can be reduced and the electricity consumed by the sensor 3 and the sensor node 4 can be reduced.

The granularity of sensor data can be adjusted, for example, by changing the frequency of collection from the sensor 3 or the number of the sensors 3 used. For example, a plurality of sensors 3 is arranged on one machine and sensor data is usually measured by one sensor 3. Then, if a failure or a sign of failure is detected in this sensor data, the plurality of sensors 3 is actuated and the granularity of sensor data can be thus improved. Alternatively, the granularity of sensor data can be improved by doubling the frequency of acquiring sensor data from the sensor 3 and thus doubling the sensor data to be collected.

In the data collection system according to the invention, the central facilities server 1 detects a change in the state such as a failure or abnormality in the subject of monitoring, and the central facilities server 1 gives the gateway 2 a command to change the granularity of sensor data from the subject of monitoring (collection rule). The gateway 2 acquires or stores the state of each of the subordinate sensors 3 in advance, then increases or decreases the frequency of collection of sensor data or the number of the sensors 3 from which to collect sensor data, the like, according to the command (collection rule) from the central facilities server 1, and thus changes the granularity of sensor data.

Thus, the central facilities server 1 no longer needs to directly control the sensor 3, and a large number of sensors 3 can be controlled if a command to change the granularity of sensor data is transmitted to the gateway 2. Therefore, an increase in the processing load on the central facilities server 1 and an increase in the communication load on the WAN 70 can be restrained while the gateway 2 controls each of the large number of sensors 3.

The subject of monitoring by the central facilities server 1 can be structures such as bridges, roads or tunnels, as well as monitoring of machines such as in plants, industrial facilities, transport equipment, or vending machines. Moreover, the subject of monitoring by the central facilities server 1 is not limited to machines and structures but can be videos and urban environments (town information) or the like.

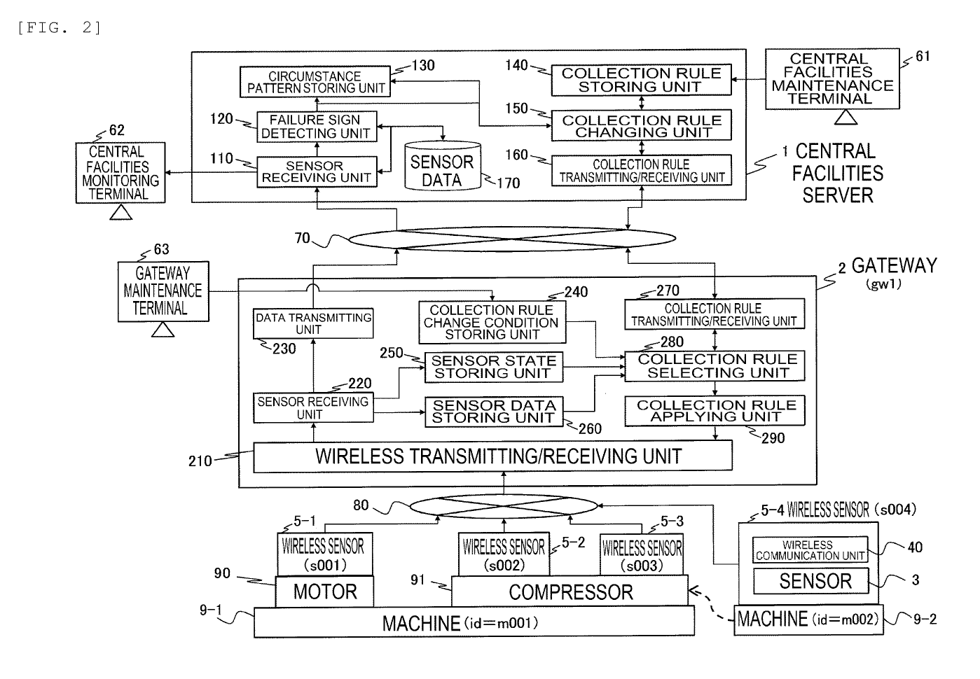

FIG. 2 is a block diagram showing an example of the configuration of the data collection system. In the example of FIG. 2, a central facilities server 1 connected to a gateway 2 via a WAN 70 and collects sensor data from wireless sensors 5-1 to 5-4 installed on machines 9-1, 9-2 as subjects of monitoring.

The machine 9-1 includes a motor 90 and a compressor 91. The wireless sensor 5-1 is installed on the motor 90, and the two wireless sensors 5-2, 5-3 are installed on the compressor 91. The wireless sensor 5-4 is stalled on the machine 9-2. Here, the machine 9-2 is a logical machine for monitoring the compressor 91 of the machine 9-1 as a single machine (id=m002). That is, the wireless sensors 5-2 to 5-4 are installed on the compressor 91. Then, the wireless sensors 5-2, 5-3 belong to the machine 9-1 with the machine id=m001 and the wireless sensor 5-4 belongs to the machine 9-2 with the machine id=m002.

The wireless sensor 5 has a sensor 3 which measures the state of the machine 9-2, and a wireless communication unit 40 which transmits sensor data measured by the sensor 3 to the gateway 2 via a FAN 80, as shown with respect to the wireless sensor 5-4. The wireless sensors 5-1 to 5-3 are configured similarly. The wireless communication unit 40 is equivalent to the sensor node 4 shown in FIG. 1. Also, the electricity for the wireless sensor 5 can be supplied from a battery (or rechargeable battery), not shown. A configuration in which the wireless sensor 5 has a solar battery panel and is thus supplied with electricity may be employed, and the wireless sensor 5 is not limited to being driven by a battery.

Also, the sensor 3 includes, for example, a temperature sensor and an acceleration sensor which measures oscillation frequency and displacement. The physical quantity measured by the sensor 3 may be selected properly according to the subject of monitoring.

The gateway 2 receives a collection rule as a command to change the granularity of sensor data, from the central facilities server 1, and selects the number of the wireless sensors 5 used for measuring sensor data and the frequency of collection so as to meet the collection rule, according to the state of the wireless sensor 5 acquired from each wireless sensor 5.

Then, the gateway 2 transmits a command about the frequency of collection to the selected wireless sensor 5 and collects sensor data. In order to rewrite information of the subordinate wireless sensor 5 and the condition for changing collection rules (described later) or the like, and to confirm information, a gateway maintenance terminal 63 including an input/output device is connected to the gateway 2.

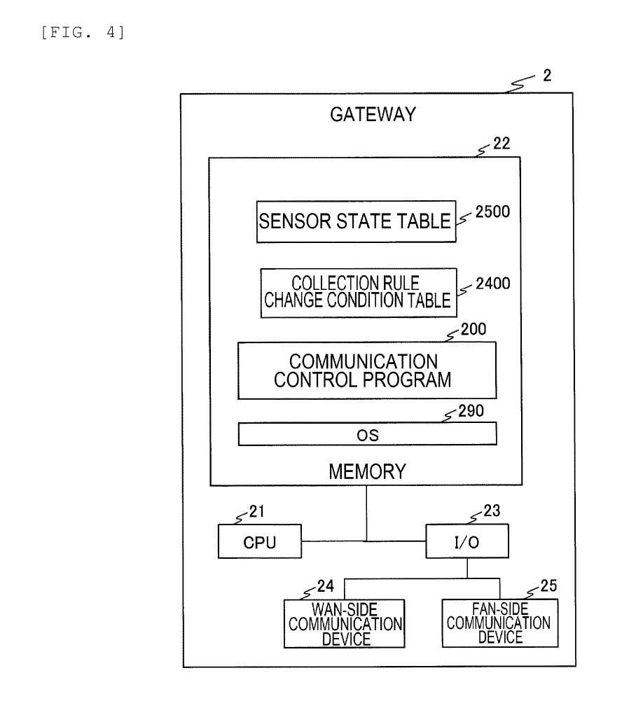

The functional elements of the gateway 2 will be described below. The gateway 2 includes a wireless transmitting/receiving unit 210 which communicates with the wireless sensor 5 via the FAN 80, a sensor receiving unit 220 which accepts sensor data from the wireless sensor 5, a data transmitting unit 230 which transmits sensor data received via the WAN 70 to the central facilities server 1, a collection rule transmitting/receiving unit 270 which accepts a collection rule from the central facilities server 1 via the WAN 70, a collection rule change condition storing unit 240 which manages a condition for changing collection rules, a sensor state storing unit 250 which manages the state of the subordinate wireless sensor 5, a sensor data storing unit 260 which temporarily holds sensor data, a collection rule selecting unit 280 which selects the wireless sensor 5 and the frequency of collection of sensor data that meet the collection rule accepted from the central facilities server 1, and a collection rule applying unit 290 which executes the collection of sensor data from the selected wireless sensor 5. These functional components are implemented as a communication control program 200 shown in FIG. 4.

In the case where the gateway 2 carries out the collection of sensor data from the wireless sensor 5 by polling, the sensor receiving unit 220 carries out processing to the wireless sensor 5 on the basis of the frequency of collection of sensor data decided by the collection rule selecting unit 280. Also, the collection rule transmitting/receiving unit 270 of the gateway 2 can transmit and receive the collection rule that is currently applied, to and from the central facilities server 1, as described below.

While the case where the gateway 2 carries out the collection of sensor data from the wireless sensor 5 by polling is described, a configuration in which the collection rule decided by the collection rule selecting unit 280 of the gateway 2 is transmitted to the wireless sensor 5 and in which the wireless sensor 5 controls the sensor 3 on the basis of the received collection rule, may be employed. For example, when the sensor 3 and the frequency of collection to be used are decided by the collection rule selecting unit 280 on the basis of anew collection rule, the gateway 2 transmits these to the wireless sensor 5 as control information of the selected sensor 3. The wireless sensor 5 acquires sensor data from the selected sensor 3 at a predetermined frequency of collection on the basis of the received control information and transmits the sensor data to the gateway 2. The wireless sensor 5 transmits the sensor data to the gateway 2, adding the machine id and the sensor id to the sensor data.

When the wireless sensor 5 to be used and the frequency of collection are decided by the collection rule selecting unit 280 on the basis of a new collection rule, the gateway 2 transmits the frequency of collection to the selected wireless sensor 5.

The wireless sensor 5 acquires sensor data from the sensor 3 on the basis of the received frequency of collection and transmits the sensor data to the gateway 2. The wireless sensor 5 transmits the sensor data to the gateway 2, adding the machine id and the sensor id to the sensor data.

The functional elements of the central facilities server 1 collecting sensor data from the gateway 2 via the WAN 70 will be described below.

The central facilities server 1 monitors the machine 9 and detects a failure or a sign of failure on the basis of the sensor data received from the gateway 2. If a failure or a sign of failure is detected, the central facilities server 1 commands the gateway 2 of the machine 9 in question to employ a new collection rule.

The central facilities server 1 includes a sensor receiving unit 110 which receives the sensor data transmitted from the gateway 2 and stores the sensor data in sensor data 170, a failure sign detecting unit 120 which detects a failure or a sign of failure in the machine 9 on the basis of the received sensor data and calculates the state of the machine 9 as a circumstance pattern, and a circumstance pattern storing unit 130 which stores the circumstance pattern of the machine 9 in a circumstance pattern table.

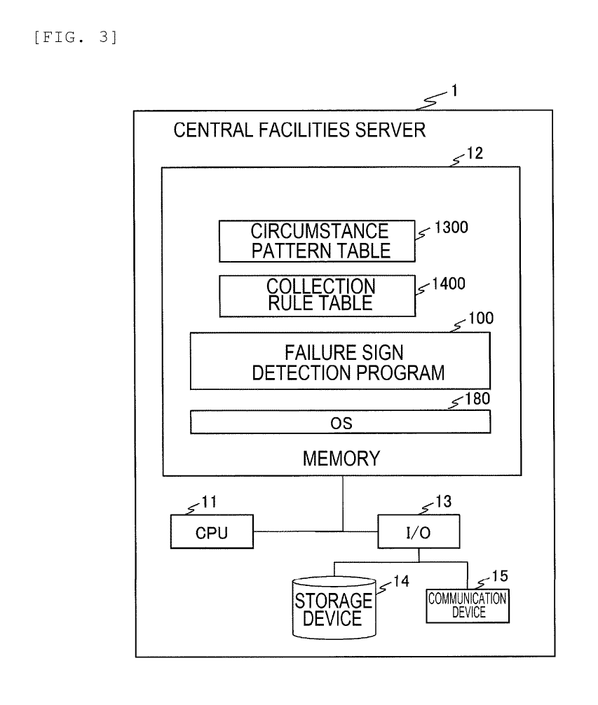

The central facilities server 1 further includes a collection rule changing unit 150 which changes the collection rule of the gateway 2 on the basis of the information stored in the circumstance pattern table managed by the circumstance pattern storing unit 130 and the circumstance pattern from the failure sign detecting unit 120, a collection rule storing unit 140 which stores collection rules in a collection rule table, and a collection rule transmitting/receiving unit 160 which transmits and receives collection rules to and from the gateway 2. These functional elements are implemented as a failure sign detection program 100 shown in FIG. 3.

Also, a central facilities monitoring terminal 62 is connected to the central facilities server 1, and with the central facilities monitoring terminal 62, a maintenance worker or the like monitors the sensor data received by the sensor receiving unit 110. Moreover, a maintenance terminal 61 for writing collection rules in the collection rule storing unit 140 and for changing collection rules is connected to the central facilities server 1.

It should be noted that the numbers of central facilities servers 1, gateways 2, wireless sensors 5 and machines 9 are not limited to those in FIG. 2.

FIG. 3 is a block diagram showing an example of the configuration of the central facilities server 1. The central facilities server 1 includes a CPU 11 which carries out arithmetic processing, a memory 12 which stores programs and data, an I/O interface 13 connected to the CPU 11, a storage device 14 which is connected to the I/O interface 13 and holds programs and data, and a communication device 15 which is connected to the I/O interface 13 and communicates with the WAN 70.

The I/O interface 13 is made up of PCI Express, for example, and carries out communications between the CPU 11 and an I/O device. The sensor data 170 shown in FIG. 2 is stored in the storage device 14.

In the memory 12, an OS 180 is loaded and executed by the CPU 11. Also, in the memory 12, a failure sign detection program 100 is loaded and executed by the CPU 11. The failure sign detection program 100 utilizes a circumstance pattern table 1300 and a collection rule table 1400 stored in the memory 12. The central facilities maintenance terminal 61 and the central facilities monitoring terminal 62 shown in FIG. 2 are connected to the central facilities server 1 via a LAN, not shown.

The failure sign detection program 100 includes each of the functional elements of the sensor receiving unit 110 to the collection rule transmitting/receiving unit 160 shown in FIG. 2. Each of the functional elements of the sensor receiving unit 110 to the collection rule transmitting/receiving unit 160 is loaded in the memory 12 as the failure sign detection program 100.

The CPU 11 performs processing according to the program of each functional unit and thus operates as a functional unit which provides a predetermined function. For example, the CPU 11 performs processing according to a collection rule change program and thus functions as the collection rule changing unit 150. The same applies to other programs. Moreover, the CPU 11 operates as a functional unit which provides each function of a plurality of kinds of processing executed by each program. A computer and computer system is a device and system including these functional units.

The information such as programs and tables to realize each of the functions of the sensor receiving unit 110 to the collection rule transmitting/receiving unit 160 can be stored in the storage device 14, a storage device such as a non-volatile semiconductor memory, hard disk drive or SSD (Solid State Drive), or a computer-readable non-temporary storage medium such as an IC card, SD card or DVD.

FIG. 4 is a block diagram showing an example of the configuration of the gateway 2. The gateway 2 includes a CPU 21 which carries out arithmetic processing, a memory 22 which stores programs and data, an I/O interface 23 connected to the CPU 21, a WAN-side communication device 24 which is connected to the I/O interface 23 and communicates with the WAN 70, and a FAN-side communication device 25 which is connected to the I/O interface 23 and communicates with the FAN 80. The I/O interface 23 is made up of PCI Express, for example, and carries out communications between the CPU 21 and an I/O device.

In the memory 22, an OS 290 is loaded and executed by the CPU 21. Also, in the memory 22, a communication control program 200 is loaded and executed by the CPU 21.

The communication control program 200 utilizes a sensor state table 2500 and a collection rule change condition table 2400 stored in the memory 22. The gateway maintenance terminal 63 shown in FIG. 2 is connected to the gateway 2 via a LAN, not shown.

The communication control program 200 includes each of the functional elements of the wireless transmitting/receiving unit 210 to the collection rule applying unit 290 shown in FIG. 2. Each of the functional elements of the wireless transmitting/receiving unit 210 to the collection rule applying unit 290 is loaded in the memory 22 as the communication control program 200.

The CPU 21 performs processing according to the program of each functional unit and thus operates as a functional unit which provides a predetermined function. For example, the CPU 21 performs processing according to a collection rule selection program and thus functions as the collection rule selecting unit 280. The same applies to other programs. Moreover, the CPU 21 operates as a functional unit which provides each function of a plurality of kinds of processing executed by each program. A computer and computer system is a device and system including these functional units.

The information such as programs and tables to realize each of the functions of the wireless transmitting/receiving unit 210 to the collection rule applying unit 290 can be stored in a storage unit, a storage device such as a non-volatile semiconductor memory, hard disk drive or SSD (Solid State Drive), or a computer-readable non-temporary storage medium such as an IC card, SD card or DVD.

FIG. 6 is a view showing an example of the circumstance pattern table 1300 managed by the circumstance pattern storing unit 130. With the circumstance pattern table 1300, the failure sign detecting unit 120 calculates a circumstance pattern 1311 on the basis of the sensor data received by the central facilities server 1 from the gateway 2, and the circumstance pattern storing unit 130 updates a present temperature 1308, a present oscillation frequency 1309 and a present displacement 1310 on the basis of the circumstance pattern 1311 and the sensor data received by the sensor receiving unit 110.

The circumstance pattern table 1300 includes a machine id 1301, a type 1302, a model number 1303, a lot number 1304, a month of manufacture 1305, a month of installation 1306, a hub identifier 1307, the present temperature 1308, the present oscillation frequency 1309, the present displacement 1310 and the circumstance pattern 1311, in one record.

As the machine id 1301, the identifier of the machine 9 that is a subject of monitoring in the data collection system is set. It suffices that the machine id 1301 is unique within the data collection system. As the type 1302, a name (or identifier) indicating the type of the machine 9 that is a subject of monitoring in the data collection system is set.

The type of machine is, for example, motor, compressor or the like. The example of FIG. 6 illustrates that motor and compressor are set as a machine indicated by the machine id 1301 of m001. This means that a motor and a compressor exist as machines belonging to the machine equipment. In this way, a machine id 1301 may be allocated to each machine 9, or a machine id may be allocated to each machine belonging to machine equipment. Thus, subjects to be monitored in the data collection system can be set freely.

As the model number 1303, the model number of the machine 9 that is a subject of monitoring in the data collection system is set. As the lot number 1304, the lot number given when the machine 9 that is a subject of monitoring in the data collection system is manufactured is set. The lot number 1304 includes information about the plant producing the machine.

As the month of manufacture 1305, the year of manufacture and the month of manufacture of the machine 9 that is a subject of monitoring in the data collection system are set. As the month of installation 1306, the year of installation and the month of installation of the machine 9 that is a subject of monitoring in the data collection system are set.

As the hub identifier 1307, a name or identifier indicating the place where the machine 9 that is a subject of monitoring in the data collection system is installed is set. It suffices that the hub identifier 1307 enables discrimination of the place where the machine 9 is installed, and the latitude, longitude and address or the like may also be used.

In this way, the machine id 1301, the type 1302, the model number 1303, the lot number 1304, the month of manufacture 1305, the month of installation 1306 and the hub identifier 1307 are saved in the circumstance pattern table 1300, and the information of the machine 9 that is a subject of monitoring in the data collection system is managed.

As the present temperature 1308, the latest temperature data of the machine 9 measured by the wireless sensor 5 is stored. The temperature data of the machine 9 can include various temperature data such as the temperature of a cover surface of the machine equipment and the temperature inside the machine 9.

As the present oscillation frequency 1309, the latest oscillation frequency of the machine 9 measured by the wireless sensor 5 is stored. The present oscillation frequency 1309 is the oscillation frequency in the longitudinal direction or lateral direction of the machine 9. As the present displacement 1310, the value of amplitude of oscillation of the machine 9 is stored.

If sensor data from a plurality of wireless sensors 5 is collected on one machine 9, as the present temperature 1308 and the present oscillation frequency 1309, a preset value such as the average value or representative value of a plurality of sensor data may be stored, or a plurality of sensor data may be stored with identifiers indicating the plurality of wireless sensors 5 or the plurality of sensors 3.

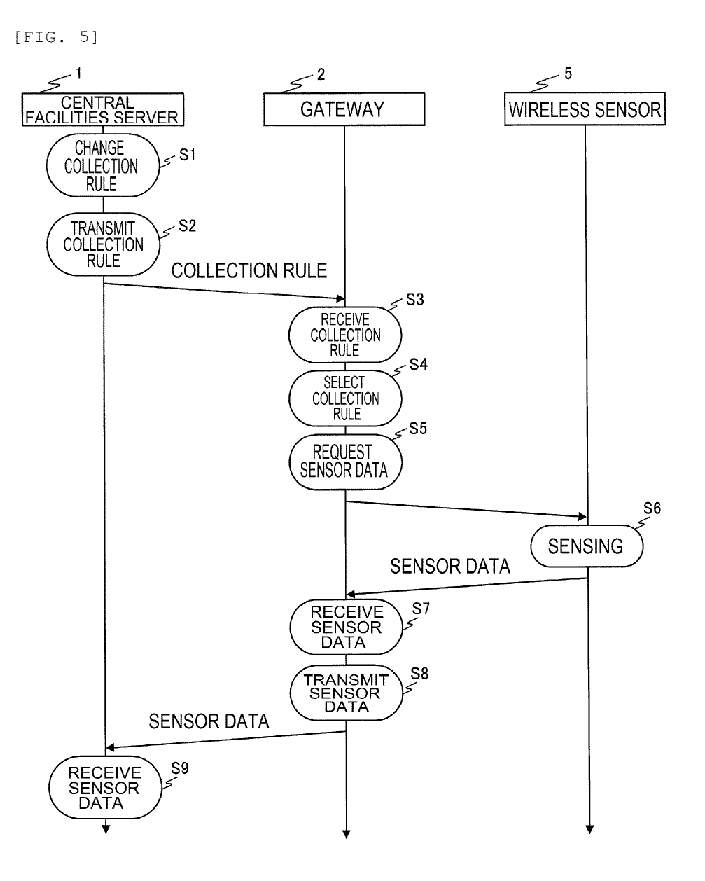

The central facilities server 1 receives the present temperature 1308, the present oscillation frequency 1309 and the present displacement 1310 on the basis of the sequence chart described in FIG. 5. In order to acquire the present temperature, present oscillation frequency and present displacement, the wireless sensor 5 uses a temperature sensor for the present temperature and an oscillation (acceleration) sensor for the present oscillation frequency and present displacement.

As the circumstance pattern 1311, a content indicating the state of the machine 9 calculated by the failure sign detecting unit 120 of the central facilities server 1 is stored. The failure sign detecting unit 120 has information including thresholds to grasp the state of the machine 9, for example, a threshold of 30° C. for the present temperature, a threshold of 70 Hz for the present oscillation frequency, and a threshold of 2.5 μm for the present displacement.

Then, the failure sign detecting unit 120 determines the state where none of the thresholds for the present temperature, present oscillation frequency and present displacement is exceeded, as a present pattern level=0. Meanwhile, the failure sign detecting unit 120 determines the state where one of the thresholds for the present temperature, present oscillation frequency and present displacement is exceeded, as a present pattern level=1. Also, the failure sign detecting unit 120 determines the state where two of the thresholds for the present temperature, present oscillation frequency and present displacement are exceeded, as a present pattern level=2.

The failure sign detecting unit 120 outputs the result of the determination based on the thresholds to the circumstance pattern storing unit 130. The circumstance pattern storing unit 130 stores the result as the circumstance pattern 1311 in the circumstance pattern table 1300.

In the example of FIG. 6, with respect to the compressor with the machine id of m001, since none of the thresholds is exceeded, the circumstance pattern is determines as level=0 and the content of the determination is saved as the circumstance pattern 1311. Meanwhile, with respect to the motor with the machine id of m001, since the present temperature exceeds the threshold of 30° C., the circumstance pattern is determined as level=1 and the content of the determination is saved as the circumstance pattern 1311. With respect to the motor with the machine id of m004, since the present temperature exceeds the threshold of 30° C., the present oscillation frequency exceeds the threshold and the present displacement exceeds the threshold as well, the circumstance pattern is determined as level=2 and the content of the determination is saved as the circumstance pattern 1311.

As for the threshold, a failure or a sign of failure can be determined using a plurality of thresholds instead of one threshold. For example, it is assumed that the threshold for the present displacement 1310 includes a first threshold of “0.4 μm”, a second threshold of “1 μm” and a third threshold of “2.5 μm”.

Then, if the present displacement 1310 is below the first threshold, the failure sign detecting unit 120 determines that this is normal and determines the circumstance pattern as level=0. If the present displacement 1310 is equal to or above the second threshold and below the third threshold, the failure sign detecting unit 120 determines that this is a sign of failure and determines the circumstance pattern as level=1. Moreover, if the present displacement 1310 exceeds the third threshold, the failure sign detecting unit 120 determines that this is a failure and determines the circumstance pattern as level=2.

In this way, as the failure sign detecting unit 120 receives the sensor data of the wireless sensor 5 from the gateway 2, the failure sign detecting unit 120 can determine the state of the machine 9 on the basis of the present temperature, present oscillation frequency and present displacement of the machine 9. By this determination, for example, it is possible to determine whether the machine 9 is in normal operation, or that there is a temperature rise due to insufficient cooling or high-load operation, or a rise in oscillation frequency and displacement due to the loosening of the fixture bolt of the machine 9.

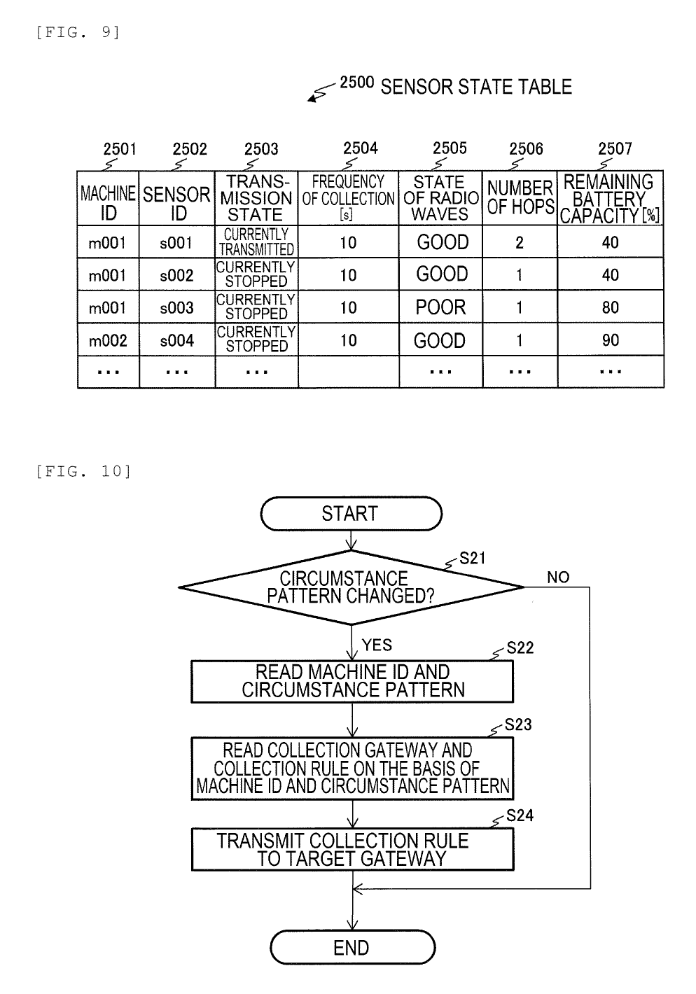

Also, if a plurality of wireless sensors 5 is installed on one machine id 1301, the failure sign detecting unit 120 calculates a plurality of circumstance patterns for each sensor id 2502 shown in FIG. 9, and sets the worst value of the circumstance patterns of the one machine 9, as the circumstance pattern 1311 in the circumstance pattern table 1300. Alternatively, if circumstance patterns are expressed by numeric values, the average value of a plurality of circumstance patterns of the one machine 9 may be set as the circumstance pattern 1311.

This example describes an example in which the circumstance pattern 1311 is calculated using the threshold for each of the present temperature 1308, the present oscillation frequency 1309 and the present displacement 1310. However, this is not limiting. The circumstance pattern may be determined according to the result of frequency analysis of the present oscillation frequency 1309 by fast Fourier transform or the like.

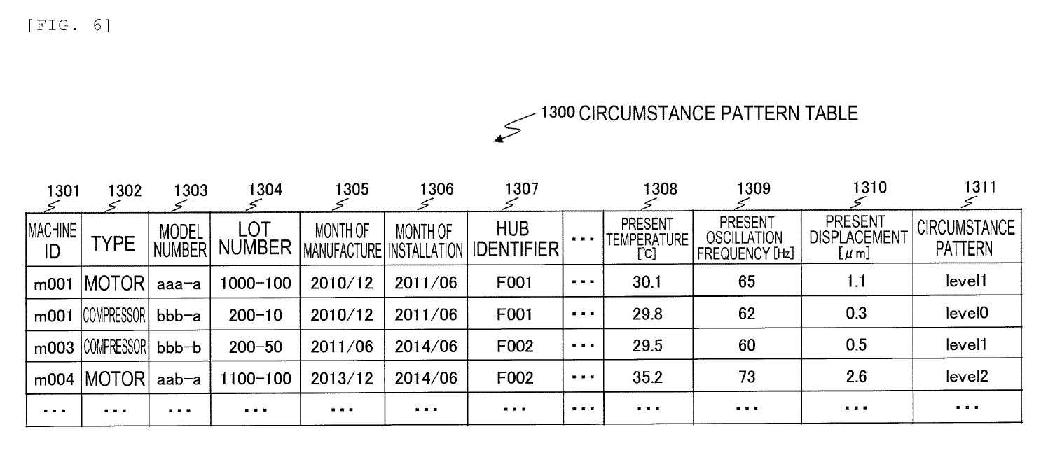

FIG. 7 is a view showing an example of the collection rule table 1400 managed by the collection rule storing unit 140 of the central facilities server 1. The collection rule table 1400 is set in advance by the central facilities maintenance terminal 61 or the like and stored in the memory 12 by the collection rule storing unit 140.

The collection rule table 1400 includes a machine id 1401, a circumstance pattern 1402, a collection gateway 1403 and a collection rule 1404, in one record.

The collection rule table 1400 is a table in which a collection rule set on the gateway 2 to collect sensor data is set in advance on the basis of the combination of the machine id 1401 and the circumstance pattern 1402 of level=0 to 2. This table 1400 is set in advance by the maintenance terminal 61 or the like and stores in the memory 12 by the collection rule storing unit 140.

The machine id 1401 is similar to the machine id 1301 in the above circumstance pattern table 1300 of FIG. 6. The circumstance pattern 1402 is similar to the circumstance pattern 1311 in the above circumstance pattern table 1300 of FIG. 6 as well.

As the collection gateway 1403, the name or identifier of a collection gateway is set on the basis of which gateway 2 is responsible for the monitoring of the machine 9 specified by the machine id 1401. For example, the machine that is set the machine id 1401 of m001 is set to be monitored, with gw1 being set as the collection gateway 1403. The machine 9 that is set the machine id 1401 of m002 is set to be monitored, with gw1 being set as the collection gateway 1403.

As the collection rule 1404, the name or identifier of the collection rule to be applied is set on the basis of the combination of the machine id 1401 and the circumstance pattern 1402. For example, if the machine id 1401 is m001 and the circumstance pattern is level=0, the collection rule indicated by pt1-0 is set. In this example, the collection rule 1404 when the machine 9 is in the normal state is set as pt1-0.

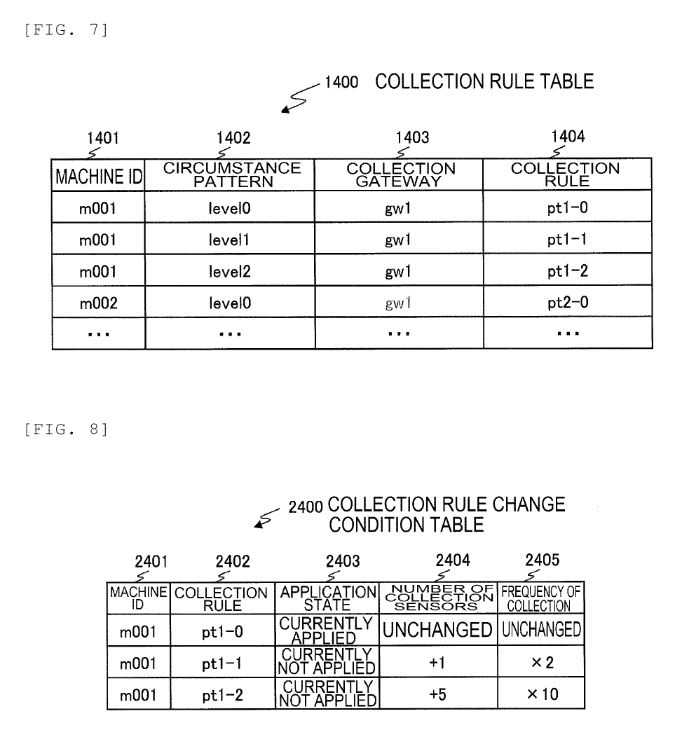

The name or identifier of the collection rule set in the collection rule table 1400 corresponds to the name or identifier of a collection rule 2402 in a collection rule change condition table 2400 described below with reference to FIG. 8.

FIG. 8 is a view showing an example of the collection rule change condition table 2400 managed by the collection rule change condition storing unit 240 of the gateway 2.

The collection rule change condition table 2400 includes a machine id 2401, a collection rule 2402, an application state 2403, a number of collection sensors 2404 and a frequency of collection 2405, in one record. The collection rule change condition table 2400 is a table in which a condition for the gateway 2 to collect sensor data from the wireless sensor 5 is set in advance on the basis of the combination of the machine and the collection rule.

As the machine id 2401, the identification number of the machine 9 is set, as in FIGS. 6 and 7 described above. As the collection rule 2402, a collection rule applicable to the machine 9 in question is set, as in FIG. 7 described above.

As the application state 2403, the collection rule 2402 applied to the machine id 2401 in question is set. This means that the collection rule 2402 corresponding to the record of the application state 2403 of “currently applied” is currently set on the machine 9 with the machine id 2401. As for the collection rule 2402 that is not applied, “currently not applied” is set as the application state 2403.

As the number of collection sensors 2404, the number of the wireless sensors 5 monitoring the machine 9 with the machine id 2401 is set. The number of the wireless sensors 5 has an initial value of 1, for example, and “+1” is added every time a command of the collection rule=Pt1-1 is given. The collection rule selecting unit 280 selects one of the plurality of wireless sensors 5 installed on the machine id 2401 and adds the one for monitoring.

In the illustrated example, if the collection rule 2402 is pt1-0, the number of the wireless sensors 5 (2404) and the frequency of collection (2405) are not changed. Meanwhile, if the collection rule 2402 is pt1-1, the number of the wireless sensors 5 is increased by one and the frequency of collection is changed to double (halve the cycle). Also, if the collection rule 2402 is pt1-2, the number of the wireless sensors 5 is increased by five and the frequency of collection is changed tenfold.

The illustrated example describes an example in which the number of collection sensors 2404 is increased. However, the circumstance pattern returns to normal after the repair of the failed part, or the like. In this way, there are cases where the circumstance pattern returns to normal (level=0) from a failure (level=2) or a sign of failure (level=1). Therefore, it is desirable to set a collection rule 2402 which decreases the number of collection sensors 2404.

As the frequency of collection 2405, the frequency (or cycle) at which the gateway 2 acquires sensor data from the wireless sensor 5 is set. For example, the initial value of the cycle at which the gateway 2 acquires sensor data from the wireless sensor 5 is set to 10 seconds.

In the illustrated example, the frequency of collection is not changed if the collection rule 2402 is pt1-0. Meanwhile, if the collection rule 2402 is pt1-1, the frequency of collection is doubled. That is, the gateway 2 acquired sensor data at a cycle of 5 seconds. Moreover, if the collection rule 2402 is pt1-2, the frequency of collection is tenfold. If this is a change from the initial value, the gateway 2 acquires sensor data at a cycle of 1 second.

In the collection rule change condition table 2400, the number of collection sensors 2404 needs to be set according to the number of the wireless sensors 5 installed in the machine 9. Therefore, it is desirable to set the collection rule change condition table 2400 from the gateway maintenance terminal 63 near the machine 9. Alternatively, the central facilities server 1 may transmit the collection rule change condition table 2400 to the gateway 2, and the gateway maintenance terminal 63 may adjust the table.

The illustrated example describes an example in which the frequency of collection 2405 is increased. However, the circumstance pattern returns to normal (level=0) from a failure (level=2) after the repair of the failed part, or the like. Therefore, if the circumstance pattern returns to normal from a failure or a sign of failure, it is desirable to set a collection rule 2402 which decreases the frequency of collection 2405.

FIG. 9 is a view showing an example of a sensor state table 2500 managed by the sensor state storing unit 250 of the gateway 2. The sensor state table 2500 is managed by the gateway 2, and states of the wireless sensor 5 and conditions for measuring sensor data are set therein. Also, the sensor state table 2500 is utilized as a table showing the quality of the wireless sensor 5.

The sensor state table 2500 includes a machine id 2501, a sensor id 2502, a transmission state 2503, a frequency of collection 2504, a state of radio waves 2505, a number of hops 2506 and a remaining battery capacity 2507, in one record.

As the machine id 2501, the identifier of the machine 9 is set, as in the circumstance pattern table 1300. As the sensor id 2502, the identifier of the wireless sensor 5 installed in the machine 9 with the machine id 2501 is given. It suffices that the sensor id 2502 is unique under the control of the gateway 2.

The transmission state 2503 indicates whether the gateway 2 is transmitting the sensor data of the wireless sensor 5 in question to the central facilities server 1 or not. For example, if the central facilities server 1 receives the sensor data of the wireless sensor 5 in question, a value of “currently transmitting” is stored. On the other hand, if the gateway 2 is not transmitting the sensor data of the wireless sensor 5 in question to the central facilities server 1, a value of “currently stopped” is stored.

As the frequency of collection 2504, a cycle at which the gateway 2 acquires the sensor data of the wireless sensor 5 in question is stored. As the state of radio waves 2505, a value evaluating the strength of radio waves transmitted from the wireless sensor 5 in question is stored. For example, if the strength of radio waves transmitted from the wireless sensor 5 exceeds a preset threshold, the gateway 2 set “good”. If the strength of radio waves is equal to or below the threshold, the gateway 2 sets “poor”. As the strength of radio waves, for example, the received signal strength indication RSSI of radio waves, or information estimated from the rate of arrival of data transmitted from the wireless sensor 5 to the gateway 2 is used.

As the number of hops 2506, the number of relay stations (or relay devices) on the channel on which the gateway 2 communicates with the wireless sensor 5 in question is stored. If the wireless sensor 5 is remote from the gateway 2, or the like, the wireless sensor 5 can communicate via a relay station subordinate to the gateway 2. As the relay station, another wireless sensor 5 may transfer the sensor data of the wireless sensor 5 in question. Also, in the illustrated example, the gateway 2 is counted as the number of hops=1.

As the remaining battery capacity 2507, the remaining capacity of the battery, not shown, that supplies electricity to the wireless sensor 5 is stored. The gateway 2 can acquire the strength of radio waves, the number of hops and the remaining battery capacity when communicating with the wireless sensor 5. The gateway 2 may inquire the remaining battery capacity 2507 or the like from the wireless sensor 5 at a predetermined timing that is different from the frequency of collection, and may store the remaining battery capacity 2507 or the like in the sensor state table 2500. The state of radio waves 2505, the number of hops 2506 and the remaining battery capacity 2507 of the wireless sensor 5 may be included in the sensor data transmitted from the wireless sensor 5 to the gateway 2, may be inquired by the gateway 2 from the wireless sensor 5 at a predetermined timing, or may be voluntarily transmitted by the wireless sensor 5 to the gateway 2.

The gateway 2 reads the sensor state table 2500, evaluates the quality information of the wireless sensor 5 and calculates the quality state of the wireless sensor 5. Also, the gateway 2 may read the sensor state table 2500, evaluate the quality information of the sensor data outputted from the wireless sensor 5 and calculate the quality state of the sensor data outputted from the wireless sensor 5.

The quality information represents data for evaluating the wireless sensor 5. The quality state represents an indicator indicating which wireless sensor 5 the gateway 2 selects sensor data from, of the sensor data of a plurality of wireless sensors 5 in the same machine 9.

The quality information of the wireless sensor 5 includes, for example, the state of radio waves 2505, the number of hops 2506 and the remaining battery capacity 2507. In the case of newly adding a wireless sensor 5, the gateway 2 selects the wireless sensor 5 with the best quality state, of the wireless sensors 5 with the state of radio waves 2505 being “currently stopped”.

Here, in terms of the quality state of the wireless sensor 5, the sensor id 2502 corresponding firstly to the state of radio waves 2505 of “good”, secondly to the number of hops 2506 that is small, and thirdly to the largest remaining battery capacity 2507, is regarded as the wireless sensor 5 with a good quality state. In this case, as indicators for selecting sensor data, the state of radio waves 2505 is a predetermined value=“good”, the number of hops 2506 is minimum, and the remaining battery capacity 2507 is maximum.

When selecting the wireless sensor 5 to be used on the basis of the quality state, the wireless sensor 5 whose quality state meets a preset condition and which meets the collection rule can be selected, other than the above. For example, as the quality state, the state of radio waves 2505, the number of hops 2506 and the remaining battery capacity 2507 may be quantified, and on the basis of the sum or product of the respective numeric values, the wireless sensor 5 with the best quality state and which meets the collection rule may be selected. For example, if the state of radio waves 2505 is “good”, the value of the quality state is defined as “1”. If the state of radio waves 2505 is “poor”, the value of the quality of state is defined as “0”. The value of the quality state of the number of hops 2506 is defined as 1/the number of hops. The value of the quality state of the remaining battery capacity 2507 is defined as the remaining battery capacity (%). Then, the wireless sensor 5 that has the maximum product of the values of the respective pieces of quality information and that meets the collection rule may be selected as the optimum wireless sensor 5.

Meanwhile, in the case where the state of radio waves 2505 or the remaining battery capacity 2507 of the wireless sensor 5 that is currently in use has fallen, if there is a wireless sensor 5 having a better quality state than the wireless sensor 5 currently in use, corresponding to the sensor id 2502 with the same machine id 2501 and with the transmission state 2503 being “currently transmitted”, the gateway 2 may replace the wireless sensor 5. The determination about the fall in the state of radio waves 2505 or the remaining battery capacity 2507 is made when the state of radio waves 2505 is changed to “poor” or when the remaining battery capacity 2507 is reduced below a predetermined threshold. Also, the gateway 2 can make the determination about the fall when the state of radio waves 2505 or the remaining battery capacity 2507 is acquired.

Also, as the transmission state 2503 and the frequency of collection 2504 in the sensor state table 2500, settings corresponding to the conditions for measuring sensor data (collection rule change condition table 2400) are stored. These settings are settings about the acquisition of sensor data, and the number of the wireless sensors 5 and the cycle at which sensor data is acquired from the wireless sensor 5 are decided.

The “currently stopped” of the wireless sensor 5 indicates the state where the gateway 2 is not transmitting the sensor data of the wireless sensor 5 in question to the central facilities server 1. Therefore, the “currently stopped” includes the state where the wireless sensor 5 is in standby with the power on, the sleep state, and the power-off state.

FIG. 5 is a sequence chart showing an example of processing of giving a collection rule command and collecting data from the wireless sensor 5, carried out by the central facilities server 1. This processing illustrates an example in which the failure sign detecting unit 120 of the central facilities server 1 detects a sign of failure, then the circumstance pattern 1311 is changed and a command to change the collection rule is given to the gateway 2.

The collection rule changing unit 150 of the central facilities server 1 detects a change of the circumstance pattern 1311 of the machine 9 from the circumstance pattern table 1300 and acquires the collection rule 1404 and the collection gateway 1403 corresponding to the changed circumstance pattern 1311 and the machine id 1301 (S1). The collection rule transmitting/receiving unit 160 of the central facilities server 1 transmits the acquired collection rule 1404 and the machine id 1301 to the collection gateway 1403 (gw1) (S2). If there is only one machine 9 as a subject of monitoring subordinate to the gateway 2, the machine id 1301 need not be specified and therefore may be omitted.

The gateway 2 (gw1) receives the collection rule and the machine id via the collection rule transmitting/receiving unit 270 (S3).

Next, the collection rule selecting unit 280 updates the field of the collection rule 2402 corresponding to the received machine id and where the application state 2403 is “currently applied”, to “currently not applied”. The collection rule selecting unit 280 updates the application state 2403 corresponding to the received machine id the collection rule 2402, to “currently applied”. Then, the collection rule selecting unit 280 acquires the number of collection sensor 2404 and the frequency of collection 2405 in this record. The collection rule selecting unit 280 selects the wireless sensor 5 to be added or changed and calculates the frequency of collection, according to the number of collection sensors 2404 and the frequency of collection 2405 (S4).

The collection rule selecting unit 280 updates the transmission state 2503 of the selected sensor id 2502 to “currently transmitted”, sets the frequency of collection 2504, and updates the sensor state table 2500.

The collection rule applying unit 290 requests sensor data from the wireless sensor 5 having the selected sensor id 2502, with the newly set frequency of collection 2504 (S5). On accepting the request from the gateway 2, the wireless sensor 5 acquires sensor data from the sensor 3 and responds to the gateway 2 (S6).

While the case where the gateway 2 carries out the collection of sensor data from the wireless sensor 5 by polling is described, a configuration in which the collection rule decided by the collection rule selecting unit 280 of the gateway 2 is transmitted to the wireless sensor 5 and in which the wireless sensor 5 controls the sensor 3 on the basis of the received collection rule may be employed. For example, as the sensor 3 to be used and the frequency of collection are decided by the collection rule selecting unit 280 on the basis of the new collection rule, the gateway 2 transmits these to the wireless sensor 5 as control information of the selected sensor 3. The wireless sensor 5 acquires sensor data from the selected sensor 3 at a predetermined frequency of collection on the basis of received control information and transmits the sensor data to the gateway 2. The wireless sensor 5 transmits the sensor data to the gateway 2, adding the machine id and the sensor id to the sensor data.

As the wireless sensor 5 to be used and the frequency of collection are decided on the basis of the new collection rule selected by the collection rule selecting unit 280, the gateway 2 transmits the frequency of collection to the selected wireless sensor 5.

The wireless sensor 5 acquires sensor data from the sensor 3 on the basis of the received frequency of collection and transmits the sensor data to the gateway 2. The wireless sensor 5 transmits the sensor data to the gateway 2, adding the machine id and the sensor id to the sensor data.

As the sensor receiving unit 220 of the gateway 2 receives the sensor data from the wireless sensor 5 (S7), the gateway 2 transmits the sensor data to the sensor data storing unit 260 and the data transmitting unit 230, adding the machine id and the sensor id to the sensor data. The data transmitting unit 230 transmits the sensor data to the central facilities server 1, adding the machine id and the sensor id to the sensor data (S8). If only one machine 9 is the subject of monitoring subordinate to the gateway 2, the machine id may be omitted.

In the central facilities server 1, the sensor receiving unit 110 accepts the sensor data and the failure sign detecting unit 120 analyzes this sensor data and detects a failure or a sign of failure (S9).

By the above processing, the detection of a failure or a sign of failure and the change of the collection rule by the central facilities server 1 are carried out. The central facilities server 1 gives a notification of the new collection rule to the gateway 2 managing the machine id where a change in the state such as a failure has occurred. The gateway 2 decides the id of the wireless sensor 5 to be added or changed and the frequency of collection 2504 on the basis of the collection rule and the machine id, and starts the acquisition of sensor data.

In this way, the central facilities server 1 only has to decide the machine 9 on which the granularity of sensor data is to be changed and the collection rule and then transmit these to the gateway 2. The gateway 2 executes detailed selection of the wireless sensor 5, setting of the frequency of collection, and management of the quality state. Therefore, since the central facilities server 1 need not control the wireless sensor 5, an increase in the processing load on the computer on the central facilities side can be restrained even in a data collection system having a large number of sensors. Also, since it suffices that the central facilities server 1 transmits the machine 9 on which the granularity of sensor data is to be changed and the collection rule to the gateway 2, an increase in the communication load on the WAN 70 to control a large number of sensors can be restrained.

Also, if there are excess wireless sensors 5 in the same machine 9, the gateway 2 can replace the wireless sensor 5 whose quality state is lowered, with a wireless sensor having a good quality state from among the excess wireless sensors 5. Since the gateway 2 autonomously manages the subordinate wireless sensors 5, the communication load on the WAN 70 can be reduced further, compared with the case where the central facilities server 1 manages the wireless sensors 5.

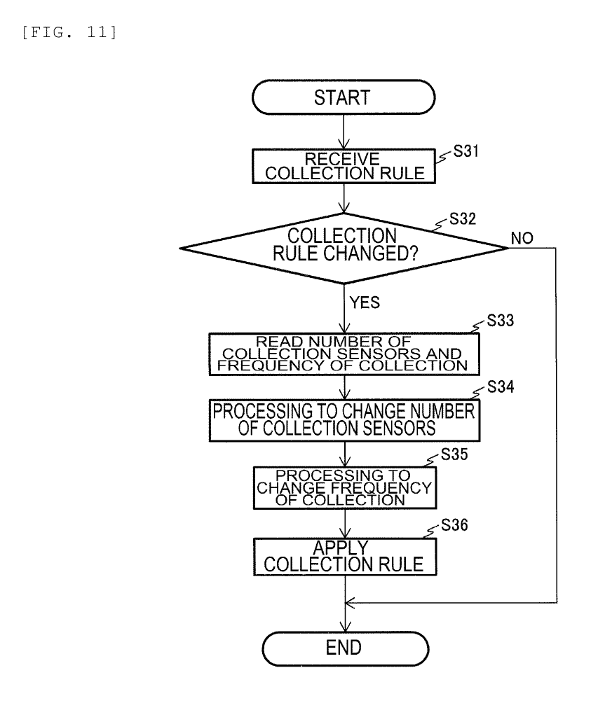

FIG. 10 is a flowchart showing an example of processing carried out by the collection rule changing unit 150 of the central facilities server 1. This processing is executed when the circumstance pattern 1311 is outputted from the failure sign detecting unit 120.

First, the collection rule changing unit 150 determines whether the failure sign detecting unit 120 has changed the circumstance pattern 1311 in the circumstance pattern table 1300 or not (S21). If the circumstance pattern 1311 is changed, the processing goes to Step S22. Meanwhile, if the circumstance pattern 1311 is not changed, the processing ends there.

In Step S22, the collection rule changing unit 150 reads the machine id 1301 on which the circumstance pattern 1311 is changed and the circumstance pattern 1311, referring to the circumstance pattern table 1300. Thus, the machine 9 where a failure or a sign of failure has occurred is specified and the circumstance pattern of this machine 9 is selected.

In Step S23, the collection rule changing unit 150 searches through the collection rule table 1400, using the machine id 1301 and the circumstance pattern 1311 that are read, and selects the collection gateway 1403 and the collection rule 1404.

In Step S24, the collection rule changing unit 150 transmits the collection rule 1404 and the machine id 1301 that are read, to the selected collection gateway 1403. Thus, if a plurality of machines 9 is installed under the gateway 2, the gateway 2 can specify which machine 9 the collection rule is to be applied.

By the above processing, if a failure or a sign of failure in the machine 9 is detected, the collection rule changing unit 150 transmits the collection rule corresponding to the circumstance pattern 1311 to the collection gateway 1403 and requests change in the granularity of sensor data.

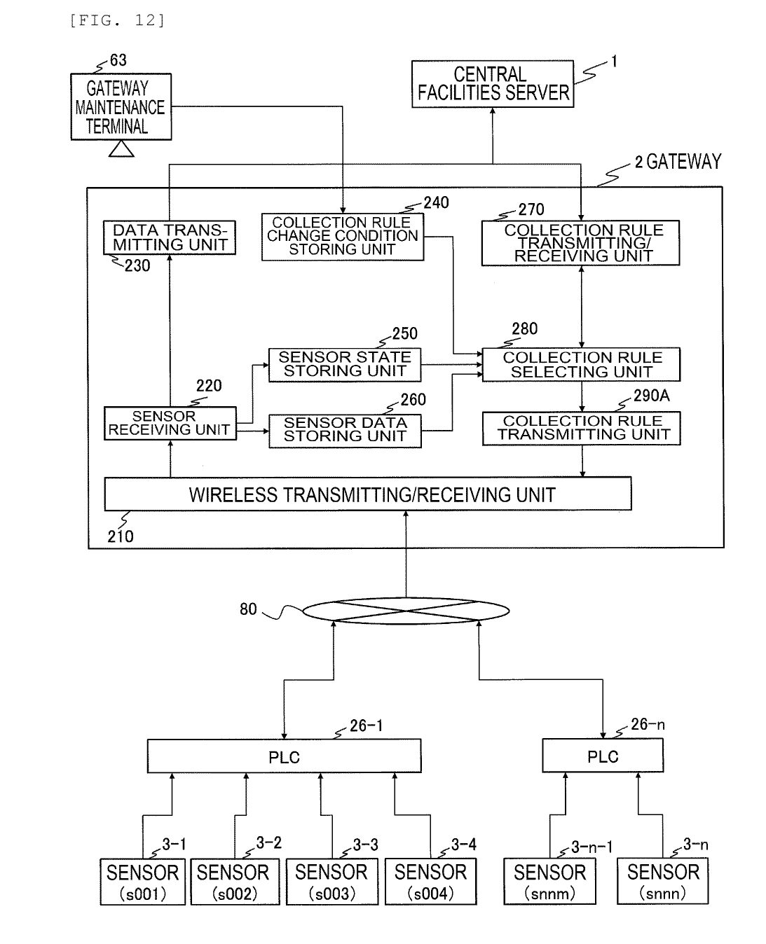

FIG. 11 is a flowchart showing an example of processing carried out by the collection rule selecting unit 280 of the gateway 2. This processing is executed when the gateway 2 receives a collection rule from the central facilities server 1.

First, the collection rule transmitting/receiving unit 270 of the gateway 2 receives a collection rule from the central facilities server 1 (S31). The collection rule selecting unit 280 determines whether the central facilities server 1 has changed the collection rule or nor (S32).

The collection rule selecting unit 280 refers to the collection rule change condition table 2400 on the basis of the received collection rule and the machine id, and determines that the collection rule is changed if the application state 2403 in the corresponding record is “currently not applied”. If the collection rule is changed, the processing goes to Step S33. Meanwhile, if the collection rule is not changed, the processing ends there.

In Step S33, the collection rule selecting unit 280 refers to the collection rule change condition table 2400 and acquires the number of collection sensors 2404 and the frequency of collection 2405 corresponding to the collection rule 2402.

In Step S34, the collection rule selecting unit 280 selects a wireless sensor 5 so as to meet the number of collection sensors 2404. For example, if the number of collection sensors increases, the collection rule selecting unit 280 selects a wireless sensor with a good quality state from among the wireless sensors 5 with the transmission state 2503 being “currently stopped” in the sensor state table 2500, and updates the transmission state 2503 to “currently transmitted”.

In Step S35, the collection rule selecting unit 280 calculates a new value so as to meet the frequency of collection 2405.

For example, in the case of increasing the frequency of collection, the collection rule selecting unit 280 acquires the frequency of collection 2504 in the sensor state table 2500, calculates a new value according to the frequency of collection 2405 in the collection rule change condition table 2400, and updates the frequency of collection 2504 in the sensor state table 2500.

In Step S36, the sensor state table 2500 updated by the collection rule selecting unit 280 is applied and the acquisition of sensor data is started with the new number of the wireless sensors 5 and the new frequency of collection.

By the above processing, when a collection rule is received from the central facilities server 1, the gateway 2 can change the number of the wireless sensors 5 which monitor the machine 9 and the frequency of collection of sensor data according to the condition for changing the collection rule and thus can change the granularity of sensor data. Since the gateway 2 monitors the quality states of a plurality of subordinate wireless sensors 5, the gateway 2 can select a stable wireless sensor in a good communication state from among the wireless sensors 5.

As described above, according to this example, if a change in a predetermined state has occurred, the central facilities server 1 transmits a new collection rule to the gateway 2 (relay device). The gateway 2 controls the granularity of sensor data outputted from the wireless sensor 5 so as to meet the collection rule on the basis of the quality of the wireless sensor 5. As the control of the wireless sensor 5 is realized solely by transfer of the collection rule, the communication volume on the WAN 70 can be reduced and an increase in the processing load and application costs on the side of the central facilities server 1 can be restrained.

Also, the control of the wireless sensor 5 in this example is the control of the granularity of sensor data. Increasing the number of the wireless sensors 5 which monitor the state of one machine 9 enables improvement in the granularity of sensor data. Also, raising the frequency of collecting sensor data from the wireless sensor 5 (reducing the cycle) enables improvement in the granularity of sensor data.

The invention achieves significant effects particularly in a large-scale data collection system. For example, it is now assumed that the number of gateways 2 is 1000 and that 500 wireless sensors 5 are connected under each gateway 2.

In the related-art example, since the central facilities server controls the wireless sensors, a command needs to be transmitted from the server to all the wireless sensors in order to control all the wireless sensors. Therefore, the server needs to transmit 500,000 commands.

In contrast, according to the invention, a collection rule only has to be transmitted to each gateway 2 once and the central facilities server 1 only has to transmit 1,000 commands. Therefore, compared with the related-art example, the processing load on the WAN 70 can be reduced significantly.

While the above Example 1 illustrates an example in which the wireless sensor 5 (sensor 3) is installed on the machine 9 as an example of the subject of monitoring, this is not limiting.

The subject of monitoring can be structures such as bridges, roads or tunnels, and videos and urban environments (town information) or the like, as well as monitoring of machines such as in plants, industrial facilities, transport equipment, or vending machines, as described above.

Also, while the above Example 1 illustrates an example in which the frequency of collection from the wireless sensor 5 is changed as an example of change in the granularity of sensor data, the sampling period of the wireless sensor 5 (sensor 3) may be changed. That is, the cycle of acquiring sensor data may be changed. One of the frequency of collection and the sampling period, or both of the frequency of collection and the sampling period may be changed.

Moreover, while the above Example 1 illustrates an example in which the number of collection sensors 2404 and the frequency of collection 2405 in the collection rule change condition table 2400 are changed in response to one collection rule, this is not limiting. For example, one of the number of collection sensors 2404 and the frequency of collection 2405 may be changed in response to one collection rule.

### Example 2

FIG. 12 is a block diagram showing a second example and showing an example of the configuration of a gateway 2 and a subordinate network. In the second example, a configuration in which the function of acquiring sensor data from a sensor 3 at a predetermined frequency of collection is offloaded onto a PLC (Programmable Logic Controller) is described. The sensor 3 is similar to the component of the wireless sensor 5 in the above Example 1.

The sensor 3 is connected to a PLC 26-1, 26-2. The PLC 26 is set to the gateway 2 via a FAN 80. In this Example 2, it is assumed that the PLC 26 includes a wireless transmitting/receiving unit and communicates with the FAN 80.

The gateway 2 has a collection rule transmitting unit 290A replacing the collection rule applying unit 290 in the configuration of FIG. 2 of the above Example 1, and the other parts of the configuration are similar to those of the above Example 1.

When the sensor 3 to be used and the frequency of collection are decided by the collection rule selecting unit 280 on the basis of a new collection rule, the gateway 2 transmits these to the PLC 26 as control information of the selected sensor 3.

The PLC 26 acquires sensor data from the selected sensor 3 at a predetermined frequency of collection on the basis of the received control information and transmits the sensor data to the gateway 2. The PLC 26 transmits the sensor data to the gateway 2, adding the machine id and the sensor id to the sensor data.

The gateway 2 receives the sensor data received from the PLC 26, via the sensor receiving unit 220, and performs processing similar to the above Example 1.

As described above, in Example 2, in the case where a large number of sensors 3 are made to belong to one gateway 2, the processing load on the gateway 2 can be reduced by outsourcing the processing of collecting sensor data from the sensors 3 to the PLC 26, in addition to the effects of the above Example 1.

Also, though an example in which the PLC 26 is used as a data collection device for collecting sensor data subordinate to the gateway 2 as a relay device is described, any device that can collect sensor data on the basis of a collection rule or control information of the sensor 3 may be employed, without being limited to the PLC 26.

Moreover, while the above Example 2 illustrates an example in which the PLC 26 and the gateway 2 are connected to each other via the FAN 80, a wired LAN can be used.

### SUMMARY

The invention is not limited to the above examples and includes various modifications. For example, the above examples are described in detail in order to explain the invention intelligibly and are not necessarily limited to those having all of the configurations described above. Also, it is possible to replace a part of the configuration of one example with the configuration of another example, and to add the configuration of one example to the configuration of another example. Moreover, with respect to a part of the configuration of each example, it is possible to apply any of the addition, deletion and replacement with another configuration, singly or in combination.

Also, a part or the whole of the respective configurations, functions, processing units and processing measures or the like described above may be realized by hardware, for example, by designing on an integrated circuit. Moreover, the respective configurations and functions or the like described above may be realized by software with a processor interpreting and executing programs for realizing the respective functions. The information such as programs, tables and files to realize each function can be stores in a recording device such as a memory, hard disk or SSD (Solid State Drive), or a recording medium such as an IC card, SD card or DVD.

As for the controls lines and information lines, those considered necessary for explanation are shown, and depending on the product, not all of the control lines and information lines are necessarily shown. In practice, it can be considered that almost all the configurations are mutually connected.

### <Supplements>

16.

The gateway according to 14., wherein

the collection rule selecting unit

changes the number of the sensors or the frequency of collecting sensor data from the sensors, on the basis of the first condition and the quality information.

17.

A method for controlling a server which has a processor and a memory and which receives sensor data from a gateway having a sensor as a subject of monitoring, the method including:

a first step in which the processor receives sensor data outputted from the sensor, from the gateway;

a second step in which the processor detects that an abnormality or a sign of abnormality has occurred in the subject of monitoring on the basis of sensor data;

a third step in which, when an abnormality or a sign of abnormality has occurred in the subject of monitoring, the processor selects a rule to change the granularity of the sensor data according to the abnormality or the sign of abnormality; and

a fourth step in which the processor transmits the selected collection rule to the gateway.

18.

The method for controlling the server according to 17., wherein

the fourth step includes

specifying the subject of monitoring in which the abnormality or the sign of abnormality has occurred, and transmitting the selected collection rule to the gateway.

19.

A method for controlling a gateway which has a processor and a memory and which transmits sensor data acquired from a sensor connected via a second network, to a server connected via a first network, the method including:

a first step in which the processor acquires and manages the state of the sensor;

a second step in which the processor selects a first condition that is set in advance according to a collection rule received from the server, and changes a setting for acquiring the sensor data on the basis of the first condition and the state of the sensor;

a third step in which the processor acquires sensor data from the sensor on the basis of the setting; and

a fourth step in which the processor transmits the sensor data to the server.

20.

The method for controlling the gateway according to 19., wherein

the second step includes

acquiring quality information of the sensor from the state of the sensor, and changing the setting for acquiring the sensor data on the basis of the first condition and the quality information.

21.

The method for controlling the gateway according to 20., wherein

the second step includes

calculating a quality state of the sensor from the quality information, and selecting a sensor the quality state of which meets a preset second condition and which meets the first condition, thereby changing the setting for acquiring the sensor data.

22.

The method for controlling the gateway according to 20., wherein

the second step includes

changing the number of the sensors or the frequency of collecting sensor data from the sensors on the basis of the first condition and the quality information.

23.

A program for a server having a processor and a memory to receive sensor data from a gateway having a sensor as a subject of monitoring, the program causing the server to execute:

a first step of receiving sensor data outputted from the sensor, from the gateway;

a second step of detecting that an abnormality or a sign of abnormality has occurred in the subject of monitoring on the basis of the sensor data;

a third step of, when an abnormality or a sign of abnormality has occurred in the subject of monitoring, selecting a rule to change the granularity of the sensor data according to the abnormality or the sign of abnormality; and

a fourth step of transmitting the selected collection rule to the gateway.

24.

A program for a gateway having a processor and a memory to transmit sensor data acquired from a sensor connected via a second network, to a server connected via a first network, the program causing the gateway to execute:

a first step of acquiring and managing the state of the sensor;

a second step of selecting a first condition that is set in advance according to a collection rule received from the server, and changing a setting for acquiring the sensor data on the basis of the first condition and the state of the sensor;

a third step of acquiring sensor data from the sensor on the basis of the setting; and

a fourth step of transmitting the sensor data to the server.

25.

The program according to 23., wherein

the fourth step includes

specifying the subject of monitoring in which the abnormality or the sign of abnormality has occurred, and transmitting the selected collection rule to the gateway.

26.

The method for controlling the gateway according to 19., wherein

the second step includes

acquiring quality information of the sensor from the state of the sensor, and changing the setting for acquiring the sensor data on the basis of the first condition and the quality information.

27.

The method for controlling the gateway according to 20., wherein

the second step includes

calculating a quality state of the sensor from the quality information, and selecting a sensor the quality state of which meets a preset second condition and which meets the first condition, thereby changing the setting for acquiring the sensor data.

28.

The method for controlling the gateway according to 20., wherein

the second step includes

changing the number of the sensors or the frequency of collecting sensor data from the sensors on the basis of the first condition and the quality information.

### REFERENCE SIGNS LIST

1 central facilities server
2 gateway
5 wireless sensor
70 WAN
80 FAN
100 failure sign detection program
110 sensor receiving unit
120 failure sign detecting unit
130 circumstance pattern storing unit
140 collection rule storing unit
150 collection rule changing unit
160 collection rule transmitting/receiving unit
200 communication control program
210 wireless transmitting/receiving unit
220 sensor receiving unit
230 data transmitting unit
240 collection rule change condition storing unit
250 sensor state storing unit
260 sensor data storing unit
270 collection rule transmitting/receiving unit
280 collection rule selecting unit
290 collection rule applying unit
1300 circumstance pattern table
1400 collection rule table
2400 sensor state table
2500 collection rule change condition table

1. A data collection system comprising:
a server having a processor and a memory;
a gateway having a processor and a memory;
a first network connecting the server to the gateway;
a plurality of sensors which is installed on a subject of monitoring and outputs sensor data; and
a second network connecting the sensors to the gateway,
wherein the server includes:
an abnormality sign detecting unit which receives the sensor data outputted by the sensors from the gateway and detects that an abnormality or a sign of abnormality has occurred in the subject of monitoring on the basis of the sensor data;
a collection rule changing unit which, when an abnormality or a sign of abnormality has occurred in the subject of monitoring, selects a collection rule to change granularity of the sensor data according to the abnormality or the sign of abnormality; and
a collection rule transmitting unit which transmits the selected collection rule to the gateway, and
the gateway includes:
a sensor state storing unit which acquires and manages states of the sensors; a collection rule selecting unit which selects a preset first condition according to the collection rule received from the server and changes a setting for acquiring the sensor data on the basis of the first condition and the states of the sensors;
a sensor receiving unit which acquires sensor data from the sensors on the basis of the setting; and
a data transmitting unit which transmits the sensor data to the server.

2. The data collection system according to claim 1, wherein
the collection rule selecting unit
acquires quality information of the sensors from the states of the sensors in the sensor state storing unit, and changes a setting for acquiring the sensor data on the basis of the first condition and the quality information.

3. The data collection system according to claim 2, wherein
the collection rule selecting unit
calculates quality states of the sensors from the quality information, and selects a sensor the quality state of which meets a preset second condition and which meets the first condition, thereby changing the setting for acquiring the sensor data.

4. The data collection system according to claim 2, wherein
the collection rule selecting unit
changes the number of the sensors or the frequency of collecting sensor data from the sensors, on the basis of the first condition and the quality information.

5. The data collection system according to claim 1, wherein
to the gateway,
the plurality of sensors installed on each of a plurality of the subjects of monitoring is connected, and
the collection rule transmitting unit of the server
specifies the subject of monitoring in which the abnormality or the sign of abnormality has occurred, and transmits the selected collection rule to the gateway.

6. A data collection method in which a server having a processor and a memory, a gateway having a processor and a memory, a first network connecting the server to the gateway, a plurality of sensors installed on a subject of monitoring and outputting sensor data, and a second network connecting the sensors to the gateway are provided and in which the server collects sensor data from the gateway, the method comprising:
a first step in which the server receives sensor data outputted from the sensors, from the gateway;
a second step in which the server detects that an abnormality or a sign of abnormality has occurred in the subject of monitoring on the basis of sensor data;
a third step in which, when an abnormality or a sign of abnormality has occurred in the subject of monitoring, the server selects a collection rule to change the granularity of the sensor data according to the abnormality or the sign of abnormality;
a fourth step in which the server transmits the selected collection rule to the gateway;
a fifth step in which the gateway acquires and manages states of the sensors;
a sixth step in which the gateway selects a first condition that is set in advance according to the collection rule received from the server, and changes a setting for acquiring the sensor data on the basis of the first condition and the states of the sensors; and
a seventh step in which the gateway acquires sensor data from the sensors on the basis of the setting and transmits the sensor data to the server.

7. The data collection method according to claim 6, wherein
the sixth step includes
acquiring quality information of the sensors from the states of the sensors, and changing the setting for acquiring the sensor data on the basis of the first condition and the quality information.

8. The data collection method according to claim 7, wherein
the sixth step includes
calculating quality states of the sensors from the quality information, and selecting a sensor the quality state of which meets a preset second condition and which meets the first condition, thereby changing the setting for acquiring the sensor data.

9. The data collection method according to claim 7, wherein
the sixth step includes
changing the number of the sensors or the frequency of collecting sensor data from the sensors on the basis of the first condition and the quality information.

10. The data collection method according to claim 6, wherein
to the gateway,
the plurality of sensors installed on each of a plurality of the subjects of monitoring is connected, and
the fourth step includes
specifying the subject of monitoring in which the abnormality or the sign of abnormality has occurred, and transmitting the selected collection rule to the gateway.

11. A server which has a processor and a memory and receives sensor data from a gateway having a sensor as a subject of monitoring, the server comprising:
an abnormality sign detecting unit which receives sensor data outputted from the sensor, from the gateway, and detects that an abnormality or a sign of abnormality has occurred in the subject of monitoring on the basis of the sensor data;
a collection rule changing unit which, when an abnormality or a sign of abnormality has occurred in the subject of monitoring, selects a collection rule to change the granularity of the sensor data according to the abnormality or the sign of abnormality; and
a collection rule transmitting unit which transmits the selected collection rule to the gateway.

12. The server according to claim 11, wherein
the collection rule transmitting unit
specifies the subject of monitoring in which the abnormality or the sign of abnormality has occurred, and transmits the selected collection rule to the gateway.

13. A gateway which has a processor and a memory and transmits sensor data acquired from a sensor connected via a second network, to a server connected via a first network, the gateway comprising:
a sensor state storing unit which acquires and manages the state of the sensor;
a collection rule selecting unit which selects a first condition that is set in advance according to a collection rule received from the server, and changes a setting for acquiring the sensor data on the basis of the first condition and the state of the sensor;
a sensor receiving unit which acquires sensor data from the sensor on the basis of the setting; and
a data transmitting unit which transmits the sensor data to the server.

14. The gateway according to claim 13, wherein
the collection rule selecting unit
acquires quality information of the sensor from the state of the sensor in the sensor state storing unit, and changes the number of the sensors or the frequency of collecting sensor data from the sensors, as the setting for acquiring the sensor data, on the basis of the first condition and the quality information.

15. The gateway according to claim 14, wherein
the collection rule selecting unit
calculates a quality state of the sensor from the quality information, and selects a sensor the quality state of which meets a preset second condition and which meets the first condition, thereby changing the setting for acquiring the sensor data.
